(19) United States
(12) Patent Application Publication
(10) Pub. No.: US 2005/0275629 A1
(43) Pub. Date: Dec. 15, 2005

(54) Mouse pad with wire-wound induction coil

(76) Inventor: Chang-Chung Chin, Hsin Tien City (TW)

Correspondence Address: LEONG C LEI, PMB # 1008, 1867 YGNACIO VALLEY ROAD, WALNUT CREEK, CA, 94598, US

(21) Appl. No.: 11/106,445

(22) Filed: Apr. 15, 2005

(30) Foreign Application Priority Data
Jun. 15, 2004 (TW) 093117237

(51) Int. Cl. G09G 5/08

(52) U.S. Cl. 345/163

(57) ABSTRACT

The present invention offers a mouse pad with wire-wound (WW) induction coil, which is designed for use with battery-free wireless optical mouse. Both the mouse pad and battery-free wireless optical mouse are equipped with induction coils. The features include: the mouse pad device includes a mouse pad of smooth surface and a loop induction coil placed under the smooth surface. At the inner edge of the mouse pad, the loop induction coil forms a closed-loop coil wound by an enameled wire, and there is a proper clearance or close contact between an incoming line and an outgoing line. Also, closed-loop coil is delivered in any geometrical form free of any coil within the inner space, such that a uniformly distributed electromagnetic field can be generated in the mouse pad and most effective electrodynamic force is induced by battery-free wireless optical mouse.

### BACKGROUND OF THE INVENTION

(a) Technical Field of the Invention

The present invention relates generally to a mouse pad with wire-wound (WW) induction coil, and more particularly to an innovative mouse pad designed for use with battery-free wireless optical mouse. The induction coil, wrapped into the mouse pad and battery-free wireless optical mouse, is a closed-loop coil of optional dimensions that is placed into the mouse pad. However, the inner space is free of any coil such that a uniformly distributed electromagnetic field can be generated in the mouse pad and most effective electrodynamic force is induced by battery-free wireless optical mouse.

(b) Description of the Prior Art

Amongst existing computer products, the new-generation wireless optical mouse has gradually become a market leader thanks to its wireless features and convenience in applications. But, the wireless optical mouse has also some disadvantages, of which the most disfavored one is that more electricity shall be required in comparison to conventional mouse.

The conventional wireless optical mouse is available with two power supplies:

One is dry battery to provide radio transmittance circuit. The disadvantage is that there will be insufficient electricity offered by dry battery after a period of time, so frequent replacement is necessary. In such case, it is likely to disturb your jobs seriously if no back-up dry battery is at hand. Additionally, more cost shall be required for procurement of batteries while environmental pollution is also a serious concern. The other one is a rechargeable battery that requires charging prior to application. The disadvantage is that wireless optical mouse with rechargeable battery has two metal contact chips in conjunction with two power contact chips on the charger. When placed onto the charger, the metal contact chips of mouse will touch the power contact chips for recharging. Nevertheless, poor contact is possible in the case of misalignment. And, the dirt on the chips will lead to over current or poor contact/recharging effect after a long-run.

In order to provide an optimum solution for “green energy”, attentions shall be paid to the convenient utilization of power supplies, indirect cost of environmental pollution and low-cost reproductive wireless induction current as well as easy radio transmission.

### SUMMARY OF THE INVENTION

The primary purpose of the present invention is to present a mouse pad with wire-wound (WW) induction coil, which is designed for use with battery-free wireless optical mouse. The battery-free wireless optical mouse is equipped with a mouse pad with induction coil, which includes a mouse pad of smooth surface and a loop induction coil placed under the smooth surface. At the inner edge of the mouse pad, the loop induction coil forms a closed-loop coil wound by an enameled wire, and there is a proper clearance or close contact between an incoming line and an outgoing line. Also, closed-loop coil is delivered in any geometrical form free of any coil within the inner space, so the power supply can be converted into a magnetic field and sent out by means of electromagnetic induction. The advantages offered by loop coil include: the electromagnetic field can be uniformly distributed around the mouse pad, namely, more magnetic flux distributed around and less amount distributed at the center of mouse pad. Thus, necessary drive current induced by battery-free wireless optical mouse can be designed to match less amount of magnetic flux at the center of mouse pad. Then, when the battery-free wireless optical mouse shifts outwards from the center of mouse pad, more magnetic flux available can provide enough induction current. The battery-free wireless optical mouse comprises: a lower casing of mouse, which is provided with a smooth surface in contact with that of the mouse pad; a mouse induction coil, installed at a location opposite to the contact surface within the lower casing of mouse, is used to receive the magnetic field from mouse pad's induction coil by way of electromagnetic induction; an inductive power supply unit, connected to the mouse induction coil, is used to convert the magnetic force of mouse induction coil into electric power. When the user places the contact surface of wireless optical mouse onto the platform of mouse pad induction coil, the induction coil of wireless optical mouse will receive the magnetic field induced by mouse pad induction coil, such that the inductive power supply is made available to the battery-free wireless optical mouse.

Of which:

The mouse pad induction coil, mounted around the mouse pad, is a closed-loop coil wound by enameled wire, such as a square closed-loop coil. In the case of switching-on, both the current direction of upper-lower coil and left-right coil of the square closed-loop coil is opposite to each other. According to the principle of magnetic conversion, the magnetic field of closed-loop coil within the mouse pad is delivered in the same direction with a certain multiplying power, and the magnetic lines occurred are uniformly distributed within the range of mouse pad in an energy-saving manner. Particularly, when the wireless optical mouse shifts outside of the mouse pad to some extent, it can dissect enough magnetic wire to provide sufficient induction current. The advantage of loop coil is that, the generated electromagnetic field can be uniformly distributed within the mouse pad, namely, more magnetic flux can be distributed around the mouse pad in the presence of enough electromagnetic field at the center. In this way, the wireless optical mouse can operate smoothly within the range of mouse pad. If a spiral arrangement is possible at the center of induction coil C, D and mouse pad A, B (refer to FIGS. 3, 4), the same current direction will be shaped between inner and outer coils at the same side owing to the outward winding modes from thin-set to thick-set or equally spaced or from thick-set to thin-set arrangements. This will lead to opposite direction of magnetic lines between inner and outer coils at the same side, so the magnetic force will counteract or fall down, setting a demand of higher power consumption for induction coil. According to the winding mode of induction coil, the magnetic field is distributed intensely at the center and thinly around. Moreover, a strong magnetic field of Z-axle over the mouse pad will likely make it difficult to comply with the telecom codes. For example, when wireless optical mouse shifts outwards from the center of mouse pad, little magnetic flux around the mouse pad is not easy to provide enough induction current in response to demanding current requirements for wireless optical mouse, thus affecting the workability of wireless optical mouse.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 shows the schematic drawing of battery-free wireless optical mouse and mouse pad.

FIG. 2 shows the illustration of battery-free wireless optical mouse pad.

FIG. 3 shows the schematic drawing of externally thick-set and internally thin-set winding modes unsuitable to the square induction coil of battery-free wireless mouse pad.

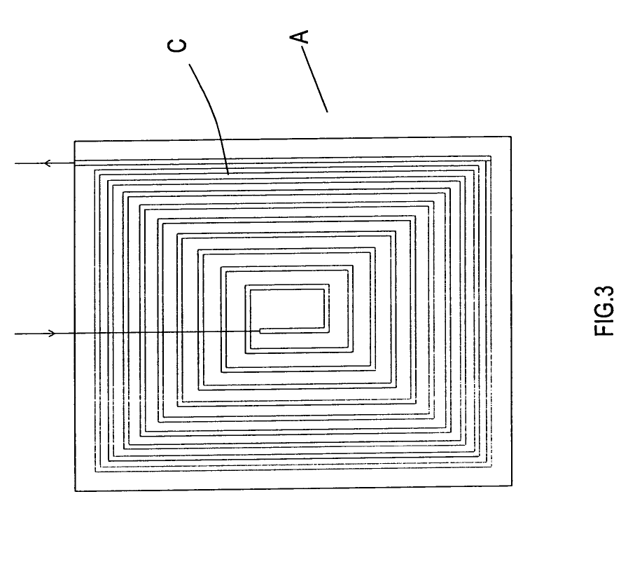

FIG. 4 shows the schematic drawing of externally thick-set and internally thin-set winding modes unsuitable to the circular induction coil of battery-free wireless mouse pad.

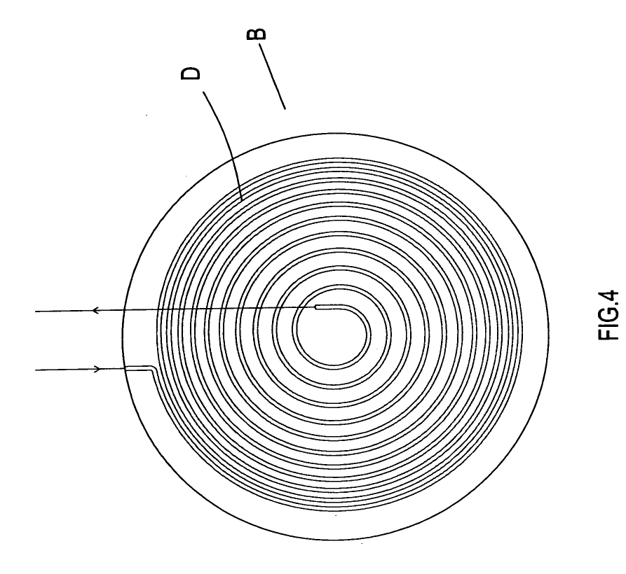

FIG. 5 shows the schematic drawing of outer hoop winding mode versus a square endless-loop winding mode for the induction coils of battery-free wireless optical mouse pad.

FIG. 6 shows the schematic drawing of outer hoop winding mode versus a square endless-loop winding mode for the induction coils of mouse pad, on which a battery-free wireless optical mouse is workable.

FIG. 7 shows the schematic drawing of outer hoop winding mode versus a circular endless-loop winding mode for the induction coils of battery-free wireless optical mouse pad.

FIG. 8 shows the schematic drawing of outer hoop winding mode versus a circular endless-loop winding mode for the induction coils of mouse pad, on which a battery-free wireless optical mouse is workable.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

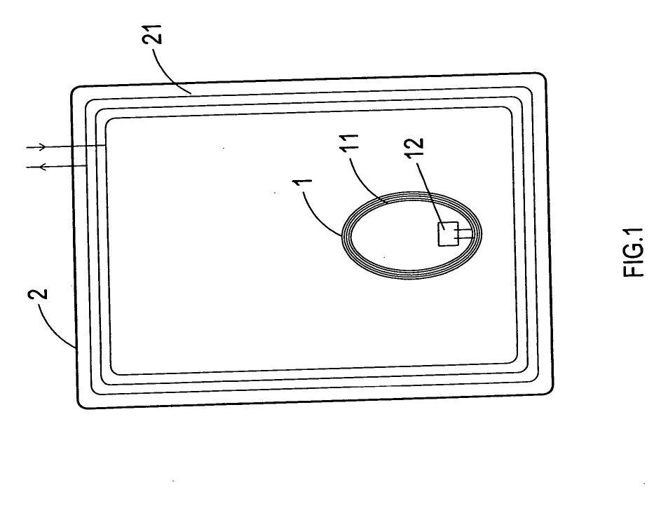

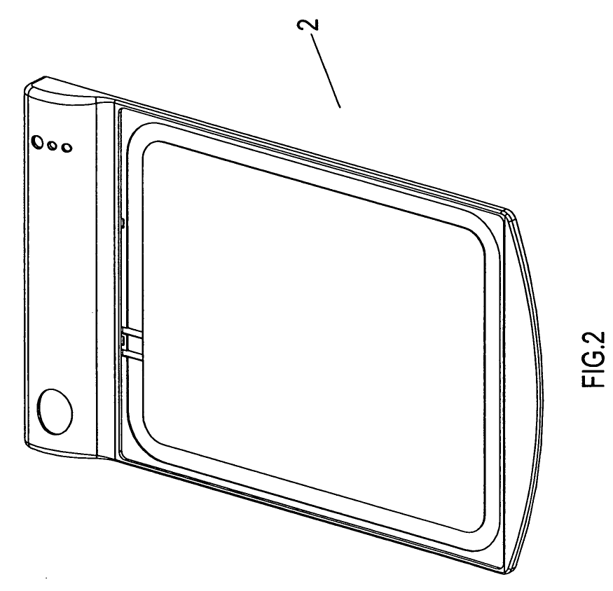

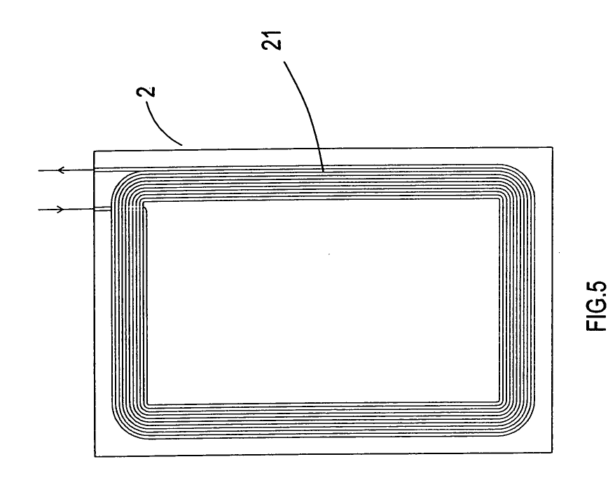

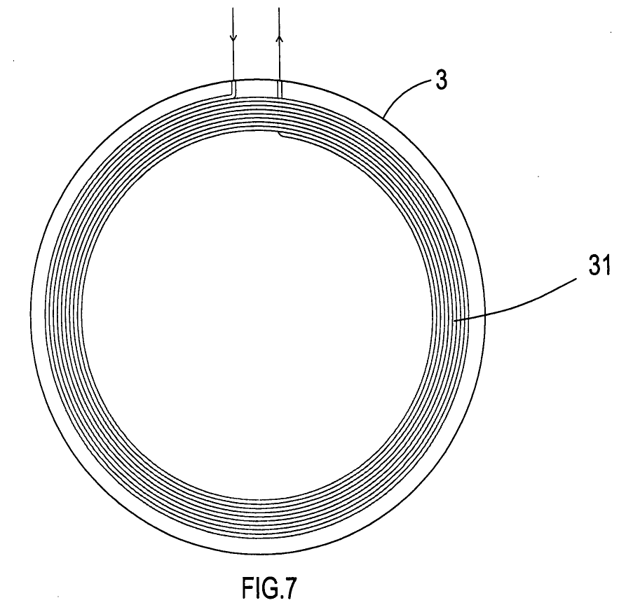

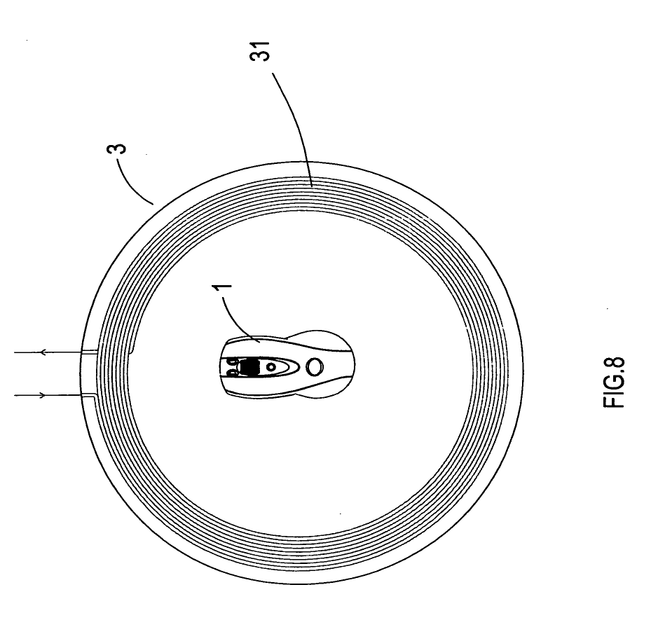

As shown in FIGS. 1, 2, a battery-free wireless optical mouse 1 may supply power via the mouse pad 2 with induction coil. The mouse pad comprises: a smooth surface mouse pad 2 and a loop induction coil 21 placed under the smooth surface. At the inner edge of the mouse pad 2, the loop induction coil 21 forms a closed-loop coil 21 wound by an enameled wire, and there is a proper clearance or close contact between an incoming line and an outgoing line. Also, closed-loop coil is delivered in any geometrical form free of any coil within the inner space (refer to FIGS. 5-8), so the power supply can be converted into a magnetic field and sent out by means of electromagnetic induction. The advantages offered by loop coil 21 31 include: the electromagnetic field can be uniformly distributed around the mouse pad 2 3, namely, more magnetic flux distributed around and less amount distributed at the center of mouse pad 2 3. Thus, necessary drive current induced by battery-free wireless optical mouse 1 can be designed to match less amount of magnetic flux at the center of mouse pad 23. Then, when the battery-free wireless optical mouse shifts outwards from the center of mouse pad 23, more magnetic flux around mouse pad 23 can provide enough induction current. The battery-free wireless optical mouse 1 comprises: a lower casing of mouse, which is provided with a smooth surface in contact with that of the mouse pad 23; a mouse induction coil 11, installed at a location opposite to the contact surface within the lower casing of battery-free wireless optical mouse 1, is used to receive the magnetic field from the closed-loop induction coil 2131 of mouse pad 23 by way of electromagnetic induction; an inductive power supply unit 12, connected to the mouse induction coil 11, is used to convert the magnetic force of mouse induction coil 11 into electric power. When the user places the contact surface of wireless optical mouse 1 onto the platform of mouse pad's close-loop induction coil 2131, the mouse induction coil 11 of wireless optical mouse 1 will receive the magnetic field induced by mouse pad induction coil 2131, such that the inductive power supply is made available to the battery-free wireless optical mouse 1.

Of which:

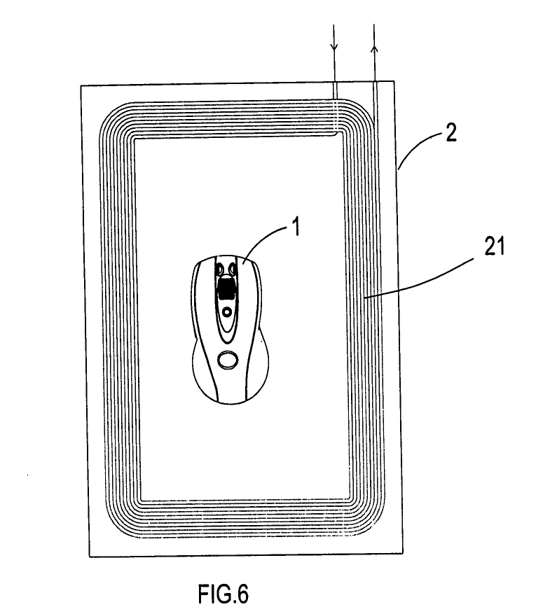

The mouse pad induction coil 21, mounted around the mouse pad, is a closed-loop coil wound by an enameled wire, such as a square closed-loop coil shown in FIGS. 5 and 6. In the event of switching-on, the current direction of upper-lower coil of the square closed-loop coil is opposite to each other as in the same case of incoming and outgoing induction lines. According to the principle of magnetic conversion, the magnetic field of closed-loop coil within the mouse pad 2 is delivered in the same direction with a certain multiplying power, and the magnetic lines occurred are uniformly distributed within the range of mouse pad 2 in an energy-saving manner. Particularly, when the wireless optical mouse 1 shifts outside of mouse pad 2 to some extent, it can dissect enough magnetic wire to provide sufficient induction current. The advantage of loop coil is that, the generated electromagnetic field can be uniformly distributed within the mouse pad 2 (as shown in FIGS. 5-8), namely, more magnetic flux can be distributed around the mouse pad 23 in the presence of enough electromagnetic field at the center. In this way, the wireless optical mouse 1 can operate smoothly within the range of mouse pad 23.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A mouse pad, well-suited for a winding mode of induction coil, comprises a battery-free wireless optical mouse and a mouse pad. And, the battery-free wireless optical mouse is available with induction coils and an inductive power supply unit, while a smooth surface of mouse pad is provided with induction coils. The features include: the mouse pad includes a mouse pad of smooth surface and a loop induction coil placed under the smooth surface. At the inner edge of the mouse pad, the loop induction coil forms a closed-loop coil wound by an enameled wire, while an incoming line and an outgoing line gain access to the center or adjacent locations of the mouse pad from lower inner edge of the exterior of smooth surface, rather than from lower inner edge of the mouse pad. When the user places the contact surface of wireless optical mouse onto the platform of mouse pad's close-loop induction coil, the mouse induction coil of wireless optical mouse will receive the magnetic field induced by mouse pad's induction coil, such that the inductive power supply is made available to the battery-free wireless optical mouse.

2. A mouse pad as defined in claim 1, a proper clearance or close contact between the induction coils.

3. A mouse pad as defined in claim 1, the inner space of induction coil free of any induction coil.

4. A mouse pad as defined in claim 1, at least one cycle for the induction coil.

5. A mouse pad as defined in claim 1, one layer or more for the winding layer of induction coil.

6. A mouse pad as defined in claim 1, copper foil line of PC board provided for the induction coil.

7. A mouse pad as defined in claim 1, enameled wire provided for the induction coil.

8. A mouse pad as defined in claim 1, flat coil provided for the induction coil.

9. A mouse pad as defined in claim 1, the induction coil is available in any closed geometrical form, including circle, oval, square, rectangle, polygon and random shapes.
